(19) United States
(12) Patent Application Publication
(10) Pub. No.: US 2006/0152776 A1
(43) Pub. Date: Jul. 13, 2006

(54) Methods and systems for generating and using a control strip on proof prints

(75) Inventor: Martin Bailey, Cambridge (GB)

Correspondence Address: DARBY & DARBY P.C., P. O. BOX 5257, NEW YORK, NY, 10150-5257, US

(73) Assignee: GLOBAL GRAPHICS SOFTWARE, INC., Cambridge (GB)

(21) Appl. No.: 11/165,821

(22) Filed: Jun. 23, 2005

Related U.S. Application Data
(60) Provisional application No. 60/582,744, filed on Jun. 23, 2004.

(51) Int. Cl. H04N 1/46

(52) U.S. Cl. 358/504

(57) ABSTRACT

A system for generating a proof print of an image for printing on media includes a processor that is arranged to generate a control strip for the print proof. The size and placement of the control strip are dynamically selectable and adjustable by the processor based, at least in part, on size of the media, size of the image, and placement of the image on the media.

### CROSS-REFERENCE TO RELATED APPLICATIONS

This application claims the benefit of U.S. Provisional Patent Application No. 60/582,744, filed on Jun. 23, 2004, which application is incorporated herein by reference in its entirety.

### FIELD

The present invention is directed to methods and systems for providing a control strip on proof prints. The present invention is also direction to methods and systems for dynamically generating a control strip for a proof print.

### BACKGROUND

A typical print production workflow will include one or more proof prints. A proof print is the output from a color printer that forms a prediction of how the final printed work will appear. The work may include a partial page, entire page, or collection of pages, referred to herein as a “job.” The proof print may include all or part of the job. The content of the proof print is typically defined in a page description file or other file format.

One purpose of the proof print is to ensure that the job can be printed effectively on the printing press or other printing device that will be used for final copies. The color on the proof prints should appear exactly the same as the final print. However, the accuracy of color reproduction in proof prints varies depending, for example, on the capability of the printer in use and the skill with which the printer has been configured. Sometimes the accuracy of the color on the proof print is not critical, for example, when the intent of the proof is to allow a proof-reader to check spelling and format.

Oftentimes proof prints are produced with a control strip in order to better assess the quality and accuracy of the printing. The control strip is designed to enable the user to validate that the capabilities and configuration of the printer are suitable for the specific job (and proof print). The control strip is a combination of text and simple graphics that is printed on the proof print along with the job. For example, the control strip may be a number of color patches that can later be measured and compared against the values that would be expected if the print has been correctly produced. In addition, such control strips may contain the name of the job that has been printed, for accurate identification.

There are several ways to add the control strip to the proof print. For example, before the job is sent to the proofing printer, the user who is operating the workflow may manually add the control strip to the page description file of the job using an appropriate page make-up or design software to edit the page description file. While editing the job, the user may add elements representing information about the job for qualifying the proof. Alternatively, the Raster Image Processor (RIP) connected to the printer may automatically add a predefined static control strip to the raster image of the proof print. The RIP is a software tool that converts the description of the job from a page description language or other file format, such as PDF or PostScript, into a raster image suitable for delivery to the printer itself. In some cases the RIP may execute on an electronic circuit board installed inside the casing of the printer itself. The control strip can be pre-defined by the user or obtained from a printing equipment supplier. If the RIP has access to more than one pre-defined control strip the RIP selects one, typically based on the size of paper that is being printed on.

As noted above the control strip allows the user to evaluate the proof print. The control strip also serves to set expectations as to the appearance of the final printed copies. In the event of any later disputes about the print job or unexpected results, it is important that the proof print can be re-evaluated appropriately. The color patches on the control strip can be re-measured (subject to compensation for any change in the color of the proof print over time, which varies with storage conditions). However, as noted above there may be variations in the color of the patches, and of the proof print as a whole, depending on the configuration of the proofing printer and of the RIP used to process the job. In addition, there may be multiple copies of the files for a job, each with slight variations from the others.

The control strips use some of the area of the paper on which the printer can print an image, thereby reducing the area available for use in printing the image of the job being proofed. In some cases the page image may therefore be truncated, or it may be scaled to fit into the remaining space. When the control strip is provided by the equipment supplier, the control strip is designed to fit on a specific media. If a different size of media is used, or if there is a need to adjust the size or position of the control strip to accommodate an unusual shape or size of job, then a new control strip may be designed by the user.

In addition to a proof print, many users perform “pre-flighting” on the job to validate that the job meets the user's criteria. The user sets the criteria to indicate whether a job will print well on the final printing press. Typically, the software used for pre-flighting is separate from the software used for proof prints. The preflight report is displayed on a computer monitor or presented in a list form. Increasingly, the pre-flighting process includes verification that a job complies with one or more standards. The standards effectively provide a set of checks for pre-flight software to make on each file. The standards may be considered in three groups: accredited standards, such as PDF/X-1a or PDF/X-3; industry standard specifications, such as standards produced by the Ghent PDF Working Group; and commercial implementation standards, such as Enfocus Certified PDF.

### BRIEF SUMMARY

One embodiment comprises a system for generating a proof print of an image for printing on media. The system includes a processor that is arranged to generate a control strip for the print proof. The size and placement of the control strip are dynamically selectable and adjustable by the processor based, at least in part, on size of the media, size of the image, and placement of the image on the media. The system may also include a printer and a computer for selecting the image.

Another embodiment is a method of making a print proof. The method includes selecting an image and media upon which the image is to be printed to form the print proof. A control strip is generated for printing on the print proof, where the form and placement of the control strip are dynamically selectable and adjustable based, at least in part, on size of the image, size of the media, and placement of the image on the media.

Yet another embodiment is a system for generating a control strip for printing with an image on media. The system includes a processor that is arranged to generate a control strip for the print proof. The control strip comprises a plurality of tints of at least one color, where the number of tints is dynamically selectable and adjustable by the processor based, at least in part, on size of the media, size of the image, and placement of the image on the media.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic illustration of a system for printing a print proof with a control strip, according to the invention;

FIGS. 2A, 2B, 2C, 2D, and 2E are schematic illustrations of embodiments of an image and a control strip on media, according to the invention;

FIGS. 3A, 3B, and 3C are schematic illustrations of embodiments of control strips, according to the invention;

FIGS. 4A, 4B, and 4C are schematic illustrations of icons showing compliance status, according to the invention; and

FIG. 5 is a flow chart of one method of generating a proof print, according to the invention.

### DETAILED DESCRIPTION

The invention relates to an improved method for reporting information about pre-printing. The present invention is directed to methods and systems for providing a control strip on proof prints. The present invention is also direction to methods and systems for dynamically generating a control strip for a proof print. A control strip is automatically and dynamically generated to include the appropriate color patches and the relevant reporting information about the print job. The control strip is produced with the job on the proof print.

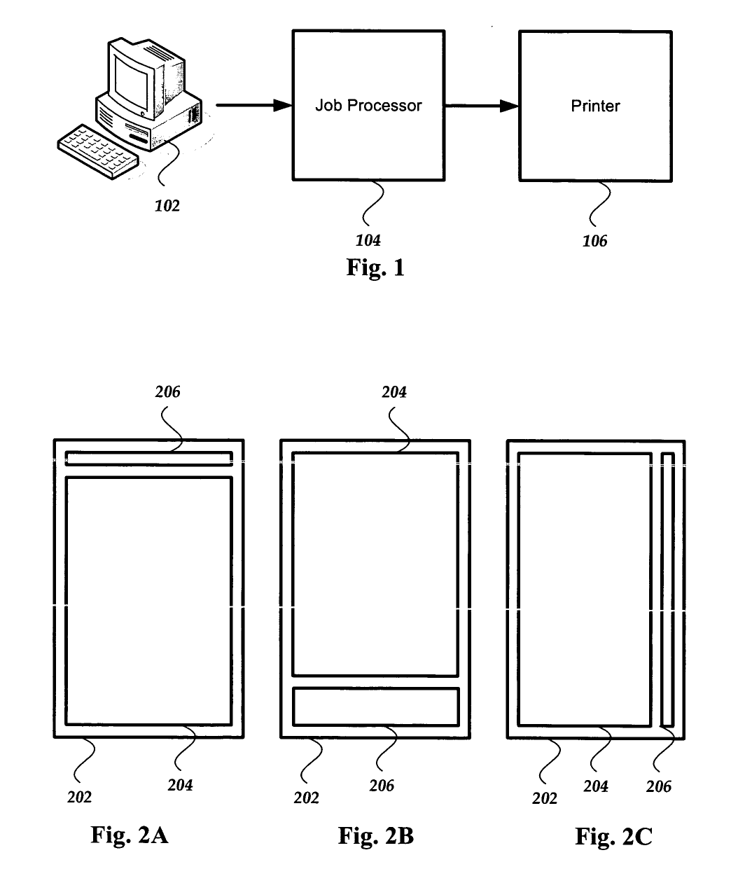

FIG. 1 illustrates one embodiment of a system for printing proofs. A computer 102 generates or stores the image to be used for the proof. The job containing the image is generated on the computer 102. The job is provided to a job processor 104 (such as a Raster Image Processor (RIP)) to convert the job into a format suitable for the printer 106. The printer 106 can be a printer, printing press or any other printing device. In one embodiment, printing is done directly from the RIP to a color printer (for example, an ink-jet printer, a laser printer, or a printer using other printing technology). If printing on a conventional printing press the RIP can be used to image onto, for example, film or plates; if onto film, then that can be used to image plates, and the plates can then be mounted on the printing press to actually perform the printing process. In some cases, especially for printing on a digital production press or imaging printing plates, the RIP may save rasterized data on a computer disk, that will be output later, often by another piece of software (often called a “shooter”), onto the paper, film, or plate. In some embodiments, software other than the RIP is used to image pre-generated rasters and apply the color management. For example, the “shooter” can be the job processor 104.

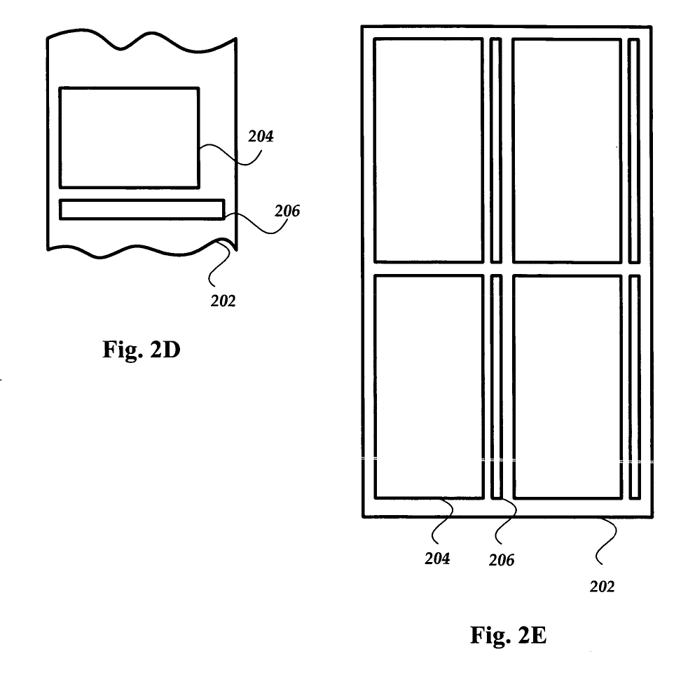

In the preferred embodiment, the Raster Image Processor (RIP) analyzes the page description file for the job and dynamically generates the content for the control strip. The RIP also automatically adjusts the form and placement of the control strip in the proof print based on factors such as media size, image size, and placement of the image on the media. FIGS. 2A, 2B, and 2C illustrate some examples of possible arrangements of an image 204 and a control strip 206 on media 202. Other placement positions, sizes, and shapes of the control strip can also be used. Any of these configurations can be used on roll media as well as sheet media. For example, FIG. 2D illustrates one example of a layout on roll media. In addition, multiple images and control strips can be placed on a single sheet of media (or printed sequentially and/or side-by-side on roll media), as illustrated, for example, in FIG. 2E.

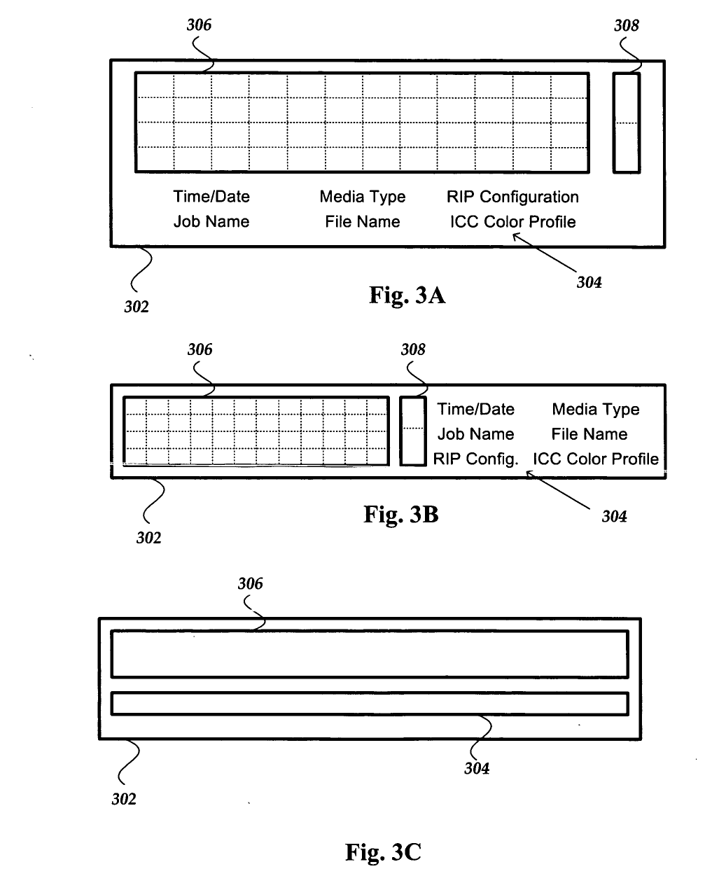

The RIP used for producing the proof print, and in the preferred embodiment generating and incorporating the control strip, is called the “proofing RIP”. In order to fully re-evaluate the quality and correctness of a proof print, it is therefore useful to record details of both the configuration and of the exact job file that was proofed. The control strip is generated based on some or all of the available information about the job, e.g., printing conditions, proofing conditions, color settings, print job profile, printer settings, RIP configuration and set-up, and the job file itself. Examples of available information include a) job name(s), the page(s) of the job printed for this proof, the file type for the job (e.g., PDF, PostScript, etc.), and the time/date of the last modification of the job file; b) the time/date at which the proof was produced; c) the spot colors, if any, used in the job; d) the output intent of the job; e) the proofing engine (the machinery that actually prints onto the media) in use; f) the resolution at which the printer is being driven; g) the media type (matte, gloss, luster; manufacturer; weight) on which the job is being printed; h) the size of the media; i) the size of the pages within the job; j) the ICC profile being used as an output device profile; and k) any other settings within the proofing RIP that would be valuable in reproducing the same configuration at a later date (generally these will be specific to the RIP in use). FIGS. 3A and 3B illustrate two examples of a control strip 302 with such information 304 provided on the strip. It will be recognized that other control strips with different arrangements and selections of information can be used. FIG. 3C illustrates another example of a control strip 302 that includes color patches 306 arranged along the width of the control strip in one or more rows (for example, one, two, or four rows) with one or more rows of information 304 disposed below (or above) the color patches.

The proofing RIP generates color patches 306 to include in the control strip 302. The color patches are based on the content of the job, the specified proofing conditions, and other available information as indicated above. The proofing RIP dynamically calculates the number and position of color patches based on media (e.g. paper) size and page size, allowing non-standard media and image sizes to be used without requiring new control strips to be manually designed or supplied by the vendor. For instance, if space is limited, e.g. because the job is being printed on a small sheet of paper, then only a small number of tints of each color for the control strip might be printed, perhaps 25%, 50%, 75% and 100% coverage. Where more space is available, more tints would be included (e.g. 1%, 2%, 5%, 10%, 25%, 50%, 75%, 90%, 95%, 98%, 99% and 100%). The number of tints on the control strip can be, for example, two, four, six, eight, ten, twelve, or any other number. There may be tints for each color of ink that this used. For example, a control strip for a CMYK printer may include tints for cyan, magenta, yellow, and black or any subcombination thereof.

The proofing RIP adapts the color patches according to the content of the job. For example, if the job file contains elements defined to print in a spot color (an ink other than those typically used for color printing on a printing press, which are usually Cyan, Magenta, Yellow and Black), then patches of solids and tints of those spot colors may be included in the control strip.

Color patches that are included to validate that a proof print has been correctly printed are called “neutral” patches, because the color printed should be near to neutral. For example, to test the color, two patches 308 can be generated: one patch is produced with a tint of Black; and the other patch is produced using tints of Cyan, Magenta and Yellow (CMY). The contrast (or similarity) between the patches indicates the accuracy of the proof prints. On a correctly generated proof print the colors of the two patches should be very similar. The combination of tints in the CMY patch varies according to the printing condition that the proof print is intended to emulate. Where a proof is being produced to predict the final color of the job on a press adjusted to match a standardized print characterization the set of neutral patches to be shown in the control strip may be selected automatically. (For example, to match a 25% Black patch when emulating SWOP requires 25% Cyan, 16% Magenta, 16% Yellow, while to emulate the print conditions described in the International Standard ISO 12647-2 requires 25% Cyan, 19% Magenta, 19% Yellow). The set of neutral patches to be shown in the control strip may be selected automatically, based on the print emulation used for that proof print.

When printing under different press conditions the final color will often vary depending on a number of factors, including the inks used and “tone value increase” (TVI). TVI is a phenomenon where the proportion of the area of the final print that is covered with ink is greater than the proportion of the area of printing plate used on the press intended to carry ink onto that paper. Different press types and different press settings lead to different TVI values. In order to allow for better and more widespread prediction of final print color, a number of standardized print characterizations have been published, each of which defines a relationship between the amount of coverage of CMYK inks and the color of the final print.

The determination of what print characterization is being emulated may be derived either from the configuration of the proofing RIP, or from data held within the input file, e.g. the “output intent” structure inside a PDF/X, or other, file. For example, the PDF file format specifications includes a structure that is designed to allow an identification of the standardized print characterization which was assumed when the colors within a PDF file were set to be encapsulated within that same file.

In addition to the color patches, the proofing RIP incorporates in the control strip, metadata about the RIP configuration, the job file, and printing conditions. The metadata is derived from the RIP setup, the job file and environmental data (such as current time and date) and other available information as indicated above. Typically the proofing RIP includes some or all of the available metadata in the control strip. In some commercial implementation duplicative or less critical information is suppressed. For example the file name of the job file is not printed if it is exactly the same as the job name. Examples of possible metadata include: a) the job name; b) the file name of the job file; c) the page or selection of the job that is shown on this proof print; d) the time and date at which the job file was last modified; e) the name of the person/software who created the job file; f) the time and date at which the proof print was rasterized (e.g., processed by the RIP); g) the named RIP configuration used to print the proof; h) the named color management configuration that formed a part of that named RIP configuration at the time of proofing; i) the International Color Consortium (ICC) color profile used within the named color management profile as an output device profile to describe the characteristics of the printer; j) the printer used to print the proof; k) the resolution at which the printer was being used; l) the halftone screening applied to the job by the RIP; m) whether the job has been scaled or cropped to fit on the media loaded in the proof printer (and, if scaled, by how much); n) an identification for the RIP used to make the proof print; and o) the feed direction of the paper through the printer, and the orientation of the job. Other items can also be printed on the control strip such as, for example, registration icons and logos or icons representing the publisher, RIP software developer, printer company, and the like.

Some or all of this metadata can be shown iconically rather than textually. This reduces the amount of media that is used to display the information and allows the same display to be used in areas where different languages are spoken. Preferably, the icons used in the control strip represent the same information as when those icons are used in the user interface of the proofing RIP. In cases where the data itself must be shown textually (e.g., a time and date), it may be labeled iconically to mark what the text describes.

A user can determine whether a particular job file matches the one used to produce the proof print by observing the control strip. Including the job-related information in the control strip reduces the potential for errors in validating and replicating the configuration used to produce that proof print.

The proofing RIP can also be used to evaluate whether the job (and proof print) are compliant with specific standards. The proofing RIP may perform its own analysis or use the results of a separately executed pre-flighting process. The results indicating whether the job complies with various standards may be represented in the control strip. This way the pre-flight report is combined with the proof print. For example the control strip may include any of the following information: a) whether the job claims to be compliant with a standard; b) an identification of the standard and version of the standard, including accredited standards and industry standard; c) specifications or commercial implementations; d) whether the job is compliant to the identified standard; and e) the print characterization or output intents for which the job was prepared.

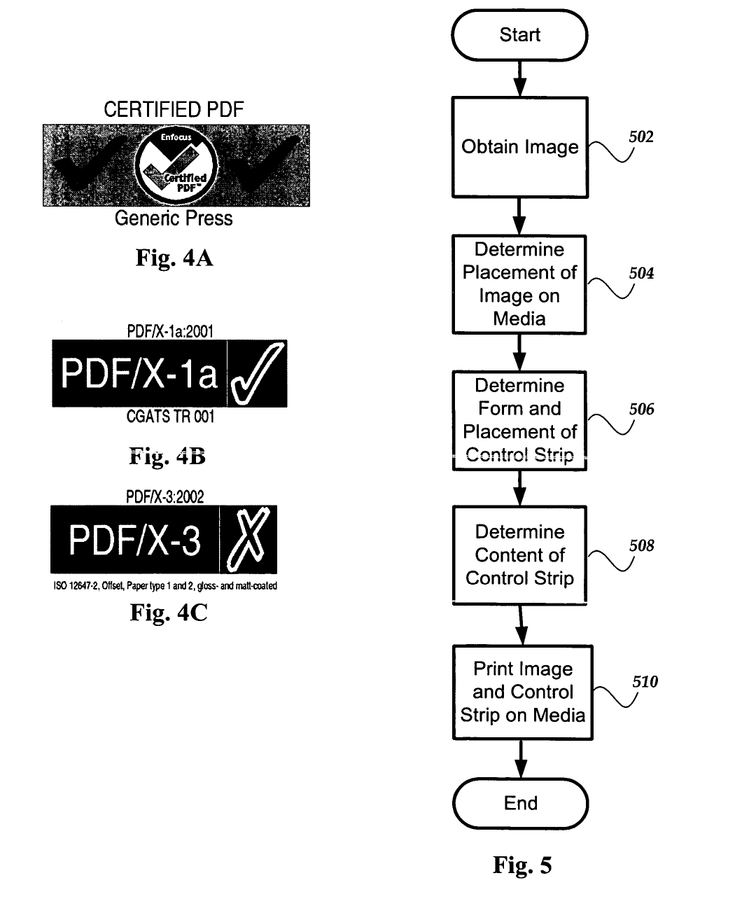

In a preferred embodiment, the compliance status is indicated with pre-defined icons. Some sample icons are provided. The icon of FIG. 4A is used for a file that conforms to the Enfocus Certified PDF specification. The icon of FIG. 4B is used for a conforming PDF/X-1a:2001 file that was prepared for output using the “CGATS TR 001” standardized print characterization. The icon of FIG. 4C is used for a file that claims to conform to PDF/X-3:2002, but which does not, in fact, do so. Other variants are used for files that do not claim to be PDF/X at all.

Where the proofing RIP determine standards compliance, and reports the results in the proof print, the use saves the need to perform a separate (and possibly manual) preflight step. The proof print also forms a hard-copy record of the state of the job at the point at which the proof was produced in addition to the more normal uses of such a proof print. The time and date of the production of the proof print is also printed within the control strip.

In the preferred embodiment, the proofing RIP automatically and dynamically adjusts the size and position of the control strip based on several factors. These factors include media type, media size, and job size. The media type may be for example, a continuous roll or supplied as pre-cut sheets. The RIP also considers whether the raster for the job is created independently of the specific media. For example, several relatively small rasters may be collected and printed together on a single sheet of media in order to save media. The media size is defined by the width of roll-fed media, or the height and width of sheet media. The job size is defined by the width, height, and total area of each printed job.

The control strips are placed on the media in such a way as to minimize the disruption to the image of the job to be proofed. The detail varies with the media type.

On roll-fed media the control strip is typically printed across the media, allowing the full width of the media to be used to print the job. The number, shape and location of color patches printed are adjusted depending on the width of the media, maximizing the amount of data presented without wasting media.

On cut-sheet media the shape and orientation of each job is compared with that of the media. For each job, one edge of the media is selected for the location of the control strip in such a way that the job can be printed without being scaled or truncated if that is possible, or to minimize the amount of the job that is truncated, or the scaling required, if the job is too large to fit. The number, shape and location of patches printed are all adjusted to make best use of the space available.

When creating raster data that is not tied to a specific media, the control strip is added along the longer edge of the page, and the number, shape and location of the patches are adjusted to construct a control strip that is the same height as the page.

FIG. 5 illustrates a flow chart of at least one method for generating a print proof. After initiating the process, at least one image is obtained for printing on predetermined media (step 502). The placement of the image is then determined (step 504). Optionally, a query can be made (at this point in the process or at another point, such as when the form and/or placement of the control strip have been determined) whether the image should be scaled to include the control strip or whether there is sufficient room for the control strip on the media. If more room is needed for the control strip (or for a desired control strip size) the image can be scaled or cropped to allow space for the control strip.

Next, the form and placement of a control strip is determined (step 506). The form includes the size and shape of the control strip. The form and placement of the control strip will depend, at least in part, on the media size, image size, and placement of the image on the media. After or simultaneously with (or even in some embodiments, before) determining form and placement of the control strip, the content of the control strip is determined (step 508). For example, content can be selected from the available information described above. In addition, the number of tints and number of colors to be displayed on the control strip can be selected, as well as the use of any spot colors and neutral color patches, as described above. Finally, the image and control strip are printed on the media (step 510).

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A system for generating a proof print of an image for printing on media, the system comprising:
a processor that is arranged to perform actions including:
generating a control strip for the print proof, wherein size and placement of the control strip are dynamically selectable and adjustable by the processor based, at least in part, on size of the media, size of the image, and placement of the image on the media.

2. The system of claim 1, wherein shape of the control strip is dynamically selectable and adjustable by the processor.

3. The system of claim 1, further comprising a printing device coupled to the processor and configured and arranged to print the image and control strip on the media.

4. The system of claim 1, wherein the control strip comprises tints of at least one color and the number of tints is dynamically selectable by the processor.

5. The system of claim 4, wherein the processor is capable of selecting at least four tints of at least one color to print in the control strip.

6. The system of claim 4, wherein the processor is capable of selecting at least 8 tints of at least one color to print in the control strip.

7. The system of claim 4, wherein the processor is capable of selecting at least 12 tints to print in the control strip.

8. The system of claim 1, wherein the control strip comprises a time and a date when the print proof is printed.

9. The system of claim 1, further comprising a computer, coupled to the processor, on which the image is selected for the print proof.

10. The system of claim 1, wherein the processor is further arranged to perform the action of determining whether the print proof complies with a predetermined standard and providing compliance information in the control strip indicating whether the print proof complies with the standard.

11. The system of claim 10, wherein the compliance information comprises an icon.

12. A method of making a print proof, the method comprising:
selecting an image and media upon which the image is to be printed to form the print proof; and
generating a control strip for printing on the print proof, wherein the form and placement of the control strip are dynamically selectable and adjustable based, at least in part, on size of the image, size of the media, and placement of the image on the media.

13. The method of claim 12, further comprising printing the image and control strip on the media.

14. The method of claim 12, further comprising determining compliance of the print proof with a predetermined standard and providing information regarding compliance on the control strip.

15. The method of claim 14, where the information regarding compliance is provided iconically.

16. The method of claim 12, wherein generating a control strip comprises selecting a plurality of tints of at least one color for display on the control strip.

17. The method of claim 12, wherein generating the control strip comprises providing a plurality of neutral patches on the control strip.

18. The method of claim 17, wherein providing a plurality of neutral patches comprises generating the neutral patches automatically based on a predetermined standard.

19. The method of claim 12, wherein generating the control strip comprises dynamically selecting and adjusting the shape of the control strip based, at least in part, on size of the image, size of the media, and placement of the image on the media.

20. The method of claim 12, wherein generating the control strip comprises dynamically selecting and adjusting the size of the control strip based, at least in part, on size of the image, size of the media, and placement of the image on the media.

21. A system for generating a control strip for printing with an image on media, the system comprising:
a processor that is arranged to perform actions including:
generating a control strip for the print proof, wherein the control strip comprises a plurality of tints of at least one color, wherein the number of tints is dynamically selectable and adjustable by the processor based, at least in part, on size of the media, size of the image, and placement of the image on the media.
